(19) United States
(12) Patent Application Publication
(10) Pub. No.: US 2004/0163096 A1
(43) Pub. Date: Aug. 19, 2004

(54) Shock absorber for disc reading device

(76) Inventors: Chun-Nan Lin, Sijhih City (TW); Sen-Chih Chan, Gueishan Township (TW); Jo Lin, Jhongli City (TW)

Correspondence Address: SNELL & WILMER, ONE ARIZONA CENTER, 400 EAST VAN BUREN, PHOENIX, AZ, 850040001

(21) Appl. No.: 10/777,624

(22) Filed: Feb. 11, 2004

(30) Foreign Application Priority Data
Feb. 17, 2003 (TW) 92103188

(51) Int. Cl. G11B 17/00; G11B 21/16

(52) U.S. Cl. 720/692; 720/688

(57) ABSTRACT

The present invention provides a shock prevention device for use in a disc-reading device. The shock prevention device includes a damper for reducing the vibration generated by a rotation motor and a compression device for compressing the damper. When the rotation motor rotates at a high speed, the compression device does not compress the damper to reduce the transmission of the high-frequency vibration. When the rotation motor rotates at a low speed, the compression device compresses the damper to prevent the amplification of the low-frequency vibration.

### CROSS-REFERENCE TO RELATED APPLICATIONS

This Application claims priority to Taiwan Patent Application No. 092103188 entitled “Shock Absorber for Disc Reading Device,” filed Feb. 17, 2003.

### FIELD OF INVENTION

The present invention relates to a shock prevention device, and more particularly, to a shock prevention device for use in a disc-reading device.

### BACKGROUND OF THE INVENTION

There are many kinds of disc reading devices on the market, such as a CD-ROM, a CD-RW and a DVD player. A disc-reading device includes a motor rotating at a high speed and causing vibration and noise. Generally, a damper is used in the disc-reading device to reduce vibration and noise generated by the rotating motor. The damper is usually assembled between the rotation motor and the housing to prevent the vibration caused by the rotation motor from being totally transmitted to the housing.

FIG. 1 is a diagram showing the relation between working frequency F and vibration transmission rate Tr of the damper in prior art. A common damper has a natural frequency ωn. When the natural frequency ωn is close, or even equal, to the working frequency F, the vibration transmission rate Tr is greater than 1. This means that vibration transmitted outward will be amplified. When the working frequency F is greater than √2 times of the natural frequency ωn, the vibration transmission rate Tr is smaller than 1. This means that vibration transmitted outward will be reduced. When the working frequency F is much smaller than the natural frequency con, the vibration transmission rate Tr is close to 1. This means that vibration transmitted outward almost doesn't have any change.

For disc-reading devices on the market now, the rotation motor can rotate at different speeds to satisfy different requirements. Generally speaking, the higher the rotation speed is, the greater the vibration caused by the motor. So, the design of the traditional damper is based on the maximum speed that the rotation motor can ever reach making the working frequency F1, generated by the rotation motor at the maximum speed, greater than √2 times of the natural frequency on of the damper. That method restrains the transmission of vibration generated by the motor at the highest speed. However, the design usually makes the natural frequency ωn close to the working frequency F2 generated at a lower speed. This means the damper not only fails in restraining vibration but amplifies the vibration transmitted outward when the rotation motor rotates at the lower speed.

### SUMMARY OF THE INVENTION

The present invention provides a shock prevention device for use in a disc-reading device, and the shock prevention device includes a compressible damper.

Another aspect of the present invention is to provide a shock prevention device which changes the natural frequency of the damper by compressing the damper.

Another aspect of the present invention is to provide a shock prevention device which restrains the vibration transmitted outward when the rotation motor vibrates at high frequency and avoids amplifying the vibration transmitted outward when the rotation motor vibrates at low frequency.

Another aspect of the present invention is to provide a shock prevention method which restrains the vibration transmitted outward when the rotation motor vibrates at high frequency and avoids amplifying the vibration transmitted outward when the rotation motor vibrates at low frequency.

The shock prevention device of the present invention includes a damper and a compression device. The damper selectively restrains the vibration generated by the rotation motor, and the compression device selectively compresses the damper. When the rotation motor is in a first state, the compression device doesn't compress the damper. When the rotation motor is in a second state, the compression device compresses the damper to increase the natural frequency of the damper.

### BRIEF DESCRIPTION OF THE DRAWINGS

FIG. 1 shows a diagram showing the relation between working frequency F and vibration transmission rate Tr of the damper in prior art.

FIG. 2a shows a schematic diagram of a disc-reading device, including an exemplary shock prevention device of the present invention.

FIG. 2b shows a profile of an exemplary shock prevention device of the present invention.

FIG. 3a shows a schematic diagram of the damper in an uncompressed state.

FIG. 3b shows a diagram showing the relation between the working frequency and vibration transmission rate of the damper in FIG. 3a.

FIG. 4a shows a schematic diagram of the damper in a compressed state.

FIG. 4b shows a diagram showing the relation between the working frequency and vibration transmission rate of the damper in FIG. 4a.

FIG. 5 shows a flow chart of the shock prevention method of the present invention.

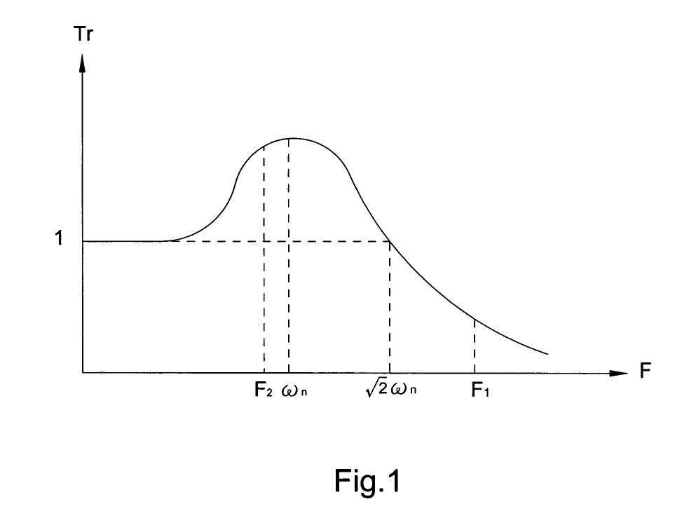

### DETAILED DESCRIPTION

The present invention provides a shock prevention device for use in a dice-reading device 300. The disc-reading device 300 has a rotation motor 310. In accordance with various embodiments, the disc-reading device 300 includes a CD-ROM, a VCD player, a DVD player, a CD-R recorder, a CD-RW recorder, a DVD recorder or the like providing similar functions.

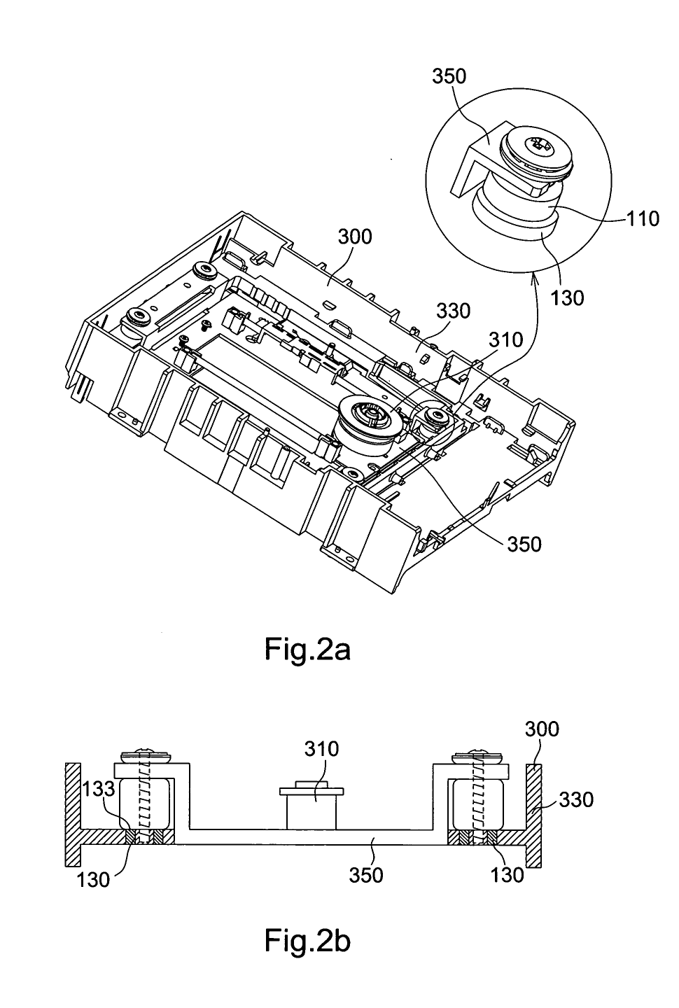

As shown in FIGS. 2a and 2b, the shock prevention device of the present invention includes a damper 110 and a compression device 130. The damper 110 selectively restrains the vibration generated by the rotation motor 310, and the compression device 130 selectively compresses the damper 110. In the embodiments illustrated in FIGS. 2a and 2b, the disc-reading device 300 includes the rotation motor 310, a rotation motor base 350 and a housing 330. In this embodiment, the damper 110 prevents the vibration generated by the rotation motor 310 from being transmitted to the housing 330 of the disc-reading device 300.

As shown in FIG. 2b, one end of the damper 110 is connected to one end of the compression device 130, and the other end of the damper is connected to the rotation motor base 350. The compression device 130 is disposed on the housing 330. In other embodiments, the compression device 130 is disposed on the rotation motor base 350, and one end of the damper 110 is connected to the housing 330 instead. In accordance with different embodiments, the damper 110 may be directly connected to the rotation motor 310.

In the illustrated embodiment of the present invention, a screw 400 maintains the relative positions of the damper 110 and the housing 330. As shown in FIG. 2b, the screw 400 passes through the damper 110 and is fixed on the housing 330 by a bolt. When the compression device 130 compresses the damper 110 upward, the top of the screw 400 provides a support force to the damper 110 to avoid the damper 110 from escaping out of the screw 400. So, the compression device 130 can compress the damper 110 using the top of the screw 400 as a base. In accordance with other embodiments, the screw 400 also can be replaced by other devices with the same function, for example, a rivet or a fixing column formed with the housing integrally.

In the illustrated embodiment, the damper 110 includes a shock-reduction rubber. In other embodiments, the damper may include a shock-reduction sponge, a polymer material, a liquid-pressure damper 110 or the like.

The compression device further includes a compression mechanism. In the illustrated embodiment, the compression mechanism stretches out through the hole of the housing to compress the damper 110. When the compression mechanism pushes the damper 110, the top surface 133 of the compression mechanism compresses the damper 110 to make its density greater. In other embodiments, the compression mechanism includes a pair of pliers. The pair of pliers compresses the damper 110 horizontally or vertically.

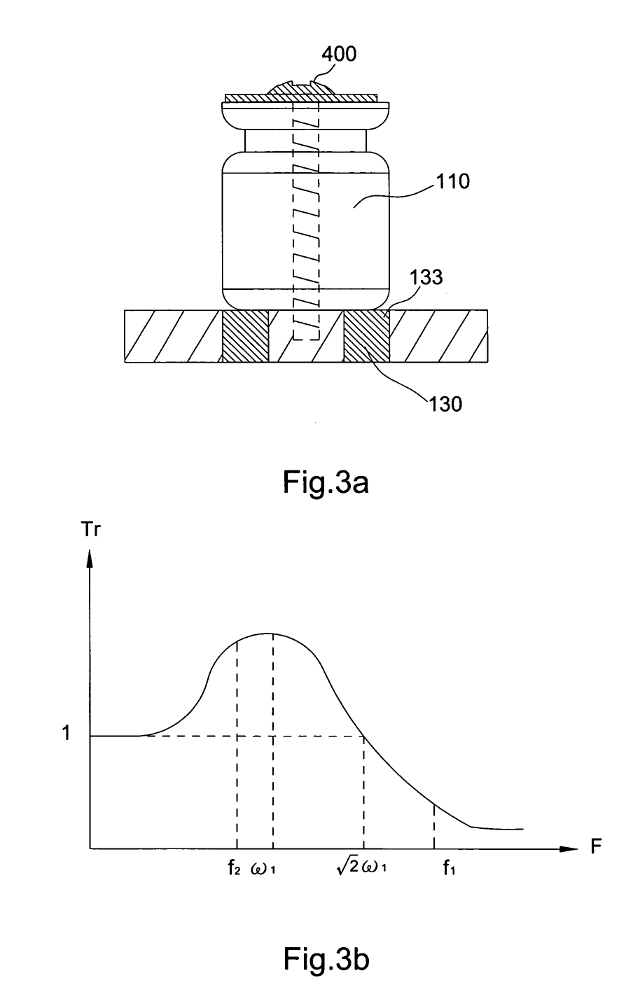

As shown in FIG. 3a, when the rotation motor 310 is in a first state, the compression device 130 doesn't compress the damper 110, and the natural frequency of the damper is ω1 at this time. FIG. 3b shows a diagram showing the relation between the working frequency and vibration transmission rate of the uncompressed damper. In the exemplary embodiment, the first state represents a first rotation speed of the motor. At this time the work frequency generated by vibration of the rotation motor 310 is f1, and f1 is greater than √2 times of ω1. In other embodiments, the first state also can represent other states of the rotation motor 310, for example, a vibration frequency, and a decibel value of noises. As shown in FIG. 3b, when the rotation motor 310 is at the first rotation speed, the vibration transmission rate is notably less than 1, revealing that the damper 110 can restrain the vibration transmitted outward

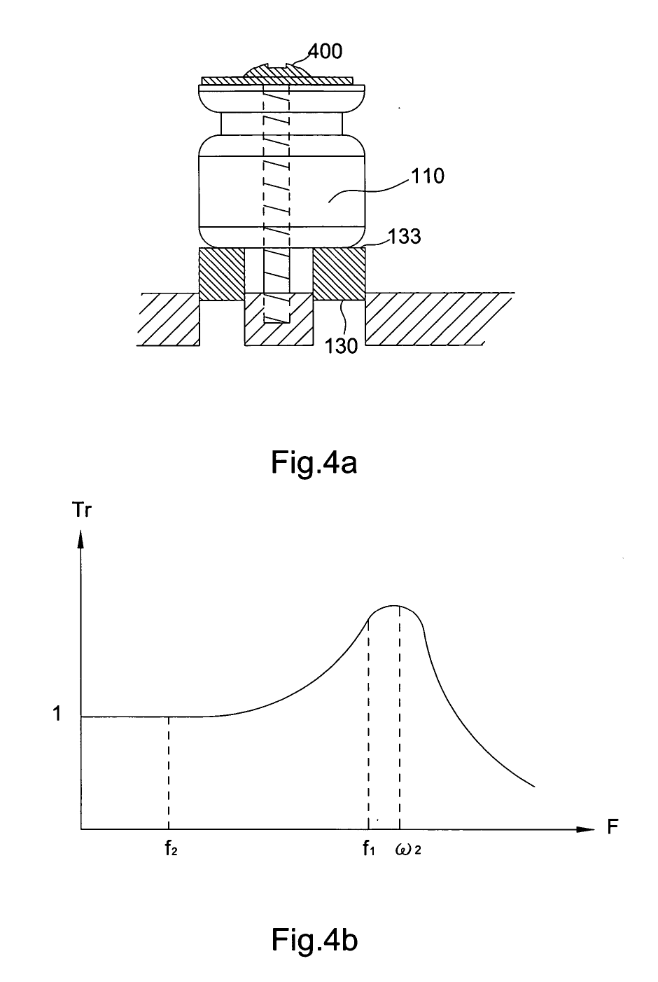

As shown in FIG. 4a, when the rotation motor 310 is at the second state, the compression device 130 compresses the damper 110. The density of the compressed damper 110 becomes greater, so the natural frequency ω2 of the compressed damper 110 is greater than the natural frequency ω1 before compressing. At this time the relation between working frequency and vibration transmission rate of the compressed damper 100 changes, as shown in FIG. 4b. In the embodiment, the second state represents a second rotation speed of the motor, and the second rotation speed is smaller than the first rotation speed. At this time the work frequency generated by vibration of the rotation motor 310 is f2, and f2 is less than f1. In other embodiments, the second state also can represent other states of the rotation motor 310, for example, a vibration frequency, and a decibel value of noises. As shown in FIG. 4b, when the rotation motor 310 is at the second rotation speed, the vibration transmission rate is approximately equal to 1, revealing that the damper 110 doesn't amplify the vibration transmitted outward.

In the illustrated embodiment, the compression device 130 further includes a detection circuit (not illustrated) to detect the state of the rotation motor 310. When the rotation motor 310 is in the first state, the detection circuit controls the compression mechanism not to compress the damper 110. When the rotation motor 310 is in the second state, the detection circuit controls the compression mechanism to compress the damper 110. Besides, the compression device 130 can compress the damper to different levels in accordance with different rotation speeds of the rotation motor 310.

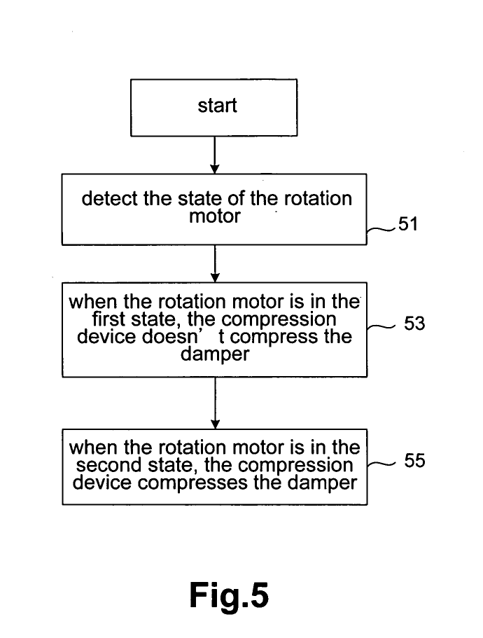

As shown in FIG. 5, the present invention also provides a shock prevention method for use in the disc reading device 300. The optical disc reading device 300 includes a rotation motor 310, a damper 110 and a compression device 130.

First, step 51 is executed to detect the state of the rotation motor 310. In the embodiment, the state here includes the rotation speed of the rotation motor 310. In other embodiments, the states can be a vibration frequency, a decibel value of noises and the like.

In step 53, when the rotation motor 310 is in the first state, the compression device 130 doesn't compress the damper 110. In step 55, when the rotation motor 310 is in the second state, the compression device 130 compresses the damper 110.

While the invention has been described in connection with what is presently considered to be the most practical and preferred embodiments, it is to be understood that the invention is not to be limited to the discovered embodiments. The invention is intended to cover various modifications and equivalent arrangements included within the spirit and scope of the appended claims.

We claim:

1. A shock absorber for use in a disc reading device, including a rotation motor, the shock absorber comprising:
a damper for selectively restraining vibration of the rotation motor; and
a compression device for selectively compressing the damper;
wherein as the rotation motor is in a first state, the compression device doesn't compress the damper, and as the rotation motor is in a second state, the compression device compresses the damper.

2. The shock absorber according to claim 1, wherein the compression device further comprises a detection circuit and a compression mechanism, and the detection circuit detects state of the rotation motor and selectively controls the compression mechanism to compress the damper.

3. The shock absorber according to claim 1, wherein the first state and the second state respectively represent different rotation speed of the rotation motor.

4. The shock absorber according to claim 1, wherein the compression device compresses the damper to increase a natural frequency of the damper.

5. A method for preventing vibration of a disc reading device, including a rotation motor, a damper and a compression device, the method comprising:
detecting state of the rotation motor; and
the compression device not compressing the damper as the rotation motor is in a first state, and the compression device compressing the damper as the rotation motor is in a second state to restrain vibration caused by the rotation motor.

6. The method according to claim 5, wherein the compression device further comprises a detection circuit and a compression mechanism, and the detection circuit detects state of the rotation motor and selectively controls the compression mechanism to compress the damper.

7. The method for according to claim 5, wherein the first state and the second state respectively represent different rotation speed of the rotation motor.

8. The method according to claim 5, wherein the compression device compresses the damper to increase a natural frequency of the damper.
